(19) United States
(12) Patent Application Publication
(10) Pub. No.: US 2018/0245809 A1
(43) Pub. Date: Aug. 30, 2018

(54) DETERMINING COSTS ASSOCIATED WITH AN HVAC SYSTEM

(71) Applicant: Honeywell International Inc., Morris Plains, NJ (US)

(72) Inventors: Petr Endel, Prague (CZ); Karel Marik, Revnice (CZ); Ondrej Holub, Prague (CZ)

(21) Appl. No.: 15/441,826

(22) Filed: Feb. 24, 2017

(51) Int. Cl. F24F 11/00; F24F 11/02; G05D 23/19; G05B 19/048

(52) U.S. Cl. CPC F24F 11/0012; F24F 11/006; F24F 11/0076; F24F 11/02; G05D 23/1923; G05B 2219/2614; F24F 2011/0046; F24F 2011/0047; F24F 2011/0064; F24F 2011/0075; G05B 19/048

(57) ABSTRACT

Devices, methods, and systems for determining costs associated with an HVAC system are described herein. One device includes a memory, and a processor configured to execute executable instructions stored in the memory to identify a number of parameters associated with a zone of an HVAC system, to input the identified parameters into a first model, estimate, using the first model, an unmeasured heat gain occurring in the zone based on the input parameters, to input actions associated with an adjustment of a temperature set point of the zone, based on the estimated unmeasured heat gain occurring in the zone and the adjustment of the temperature set point of the zone, into a second model, and determine, using the second model, a cost associated with the adjustment of a temperature set point of the zone based on the estimated unmeasured heat gain occurring in the zone.

### CROSS REFERENCE TO RELATED APPLICATION

This application is related to U.S. application Ser. No. 14/926,881, filed Oct. 29, 2015, which is incorporated herein by reference in its entirety.

### TECHNICAL FIELD

The present disclosure relates to devices, methods, and systems for determining costs associated with an HVAC system.

### BACKGROUND

A heating, ventilation, and air conditioning (HVAC) system can be used to control the climate within a facility (e.g., building). For example, an HVAC system can include a number of components that can be used to control the air temperature of different zones (e.g., rooms, areas, spaces, and/or floors) of a facility, in order to keep the zones in a comfort state for their occupants.

The occupants of a facility, and/or the operators (e.g., managers) of the HVAC system of the facility, however, may have little or no awareness of the costs associated with keeping the zones of the facility in a comfort state. For example, the occupants of the facility, and/or the operators of the HVAC system of the facility, may have little or no awareness of the costs associated with (e.g., resulting from) adjustments (e.g., increases or decreases) of the temperature set points of the zones that may be made to keep the zones in a comfort state.

Further, the occupants of the facility, and/or the operators of the HVAC system of the facility, may have little or no awareness of the costs associated with maintaining, or not maintaining, the components of the HVAC system used to keep the zones in a comfort state. For example, the occupants of the facility, and/or the operators of the HVAC system of the facility, may have little or no awareness of the costs associated with the failure of the components of the HVAC system used to keep the zones in a comfort state.

### BRIEF DESCRIPTION OF THE DRAWINGS

FIG. 1 illustrates an example of a system for determining costs associated with an HVAC system in accordance with one or more embodiments of the present disclosure.

FIG. 2 illustrates an example of a system for determining costs associated with an HVAC system in accordance with one or more embodiments of the present disclosure.

FIG. 3 illustrates a computing device for determining costs associated with an HVAC system in accordance with one or more embodiments of the present disclosure.

### DETAILED DESCRIPTION

Devices, methods, and systems for determining costs associated with an HVAC system are described herein. For example, one or more embodiments include a memory, and a processor configured to execute executable instructions stored in the memory to identify a number of parameters associated with a zone of an HVAC system of a facility to input into a first model, input the identified parameters into the first model, estimate, using the first model, an unmeasured heat gain occurring in the zone based, at least in part, on the input parameters, input actions associated with an adjustment of a temperature set point of the zone, based on the estimated unmeasured heat gain occurring in the zone and the adjustment of the temperature set point of the zone, into a second model, and determine, using the second model, a cost associated with the adjustment of a temperature set point of the zone based, at least in part, on the estimated unmeasured heat gain occurring in the zone.

Embodiments of the present disclosure may be able to determine the costs associated with keeping the zones (e.g., rooms, areas, spaces, and/or floors) of an HVAC system of a facility in a comfort state for their occupants, such as, for instance, the costs associated with (e.g., resulting from) adjustments (e.g., increases or decreases) of the temperature set points of the zones that may be made to keep the zones in a comfort state. Further, embodiments of the present disclosure may be able to determine the costs associated with maintaining, or not maintaining, the components of the HVAC system used to keep the zones in a comfort state, such as, for instance, the costs associated with the failure of the components of the HVAC system used to keep the zones in a comfort state.

Further, embodiments of the present disclosure may be able to determine the costs associated with keeping the zones of an HVAC system in a comfort state, and/or the costs associated with maintaining, or not maintaining, the components of the HVAC system used to keep the zones in a comfort state, more effectively and/or accurately than previous approaches. For example, embodiments of the present disclosure may be able to take into account unmeasured (e.g., internal) heat gains occurring in the zones when determining the costs associated with keeping the zones in a comfort state, and/or the costs associated with maintaining, or not maintaining, the components of the HVAC system used to keep the zones in a comfort state.

In contrast, previous approaches for determining the costs associated with keeping the zones of an HVAC system in a comfort state, and/or the costs associated with maintaining, or not maintaining, the components of the HVAC system used to keep the zones in a comfort state, may not take unmeasured heat gains occurring in the zones into account. For example, previous approaches for determining the costs associated with keeping the zones of an HVAC system in a comfort system may rely solely on the amount (e.g., number of degrees) by which the temperature set point of the zones is being adjusted to keep the zones in the comfort state, which may only provide a rough estimate of the costs associated with the adjustment. Further, previous approaches for determining the costs associated with maintaining, or not maintaining, the components of the HVAC system used to keep the zones in a comfort state may rely on preventative (e.g., scheduled) maintenance that does not take into account the actual operating conditions of the components, and/or on reactive maintenance that waits until the components have already failed.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

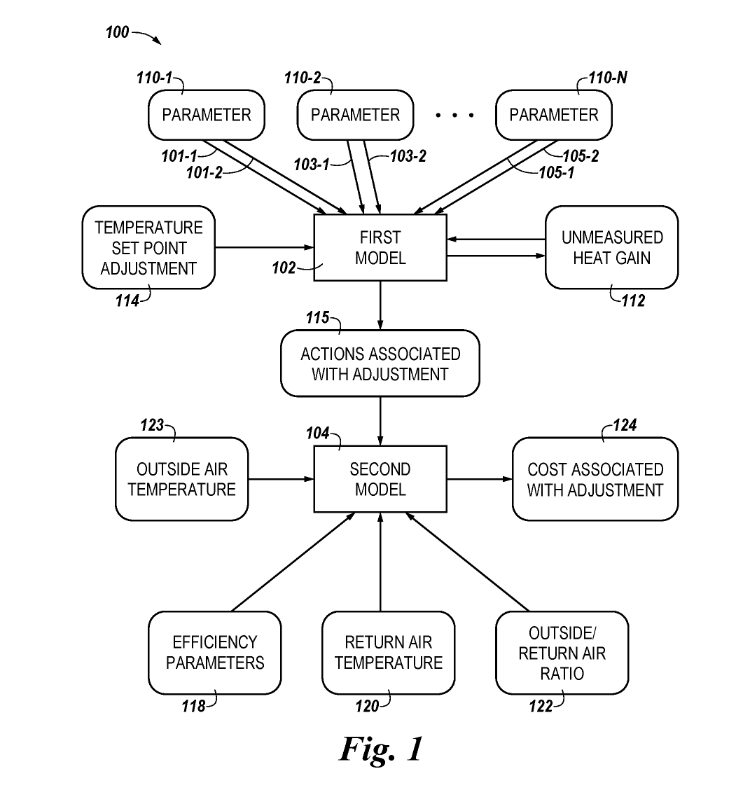

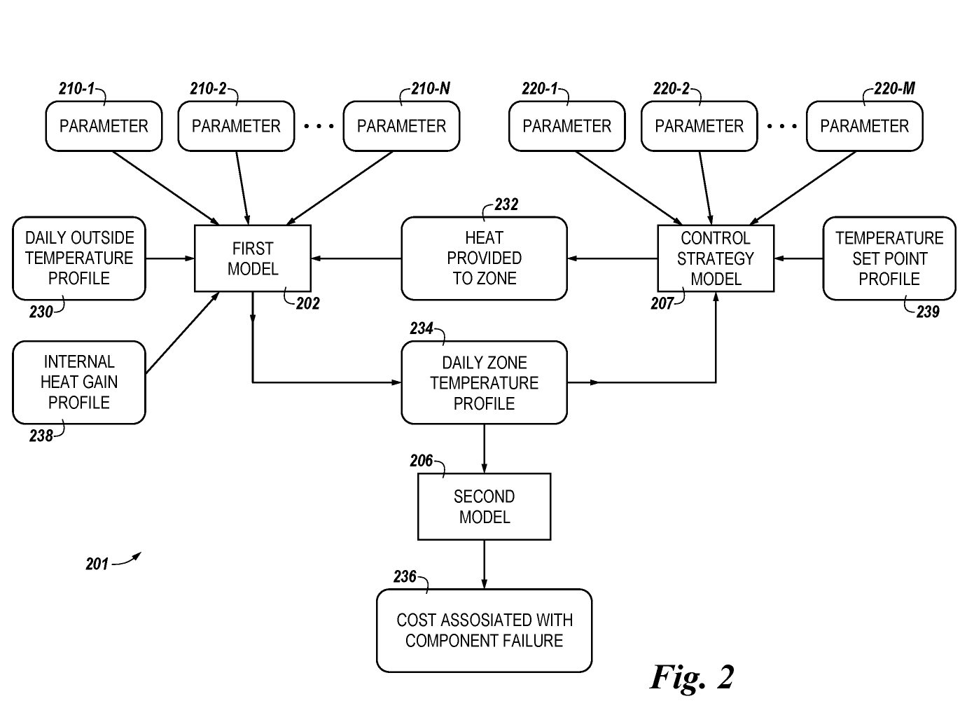

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of parameters” can refer to one or more parameters. Additionally, the designators “N” and “M” as used herein, particularly with respect to reference numerals in the drawings, indicates that a number of the particular feature so designated can be included with a number of embodiments of the present disclosure.

FIG. 1 illustrates an example of a system 100 for determining costs associated with an HVAC system in accordance with one or more embodiments of the present disclosure. For instance, system 100 can be used to determine the costs associated with keeping the zones of the HVAC system in a comfort state, such as the costs associated with (e.g., resulting from) adjustments (e.g., increases or decreases) of the temperature set points of the zones that may be made to keep the zones in a comfort state, as will be further described herein.

The HVAC system can be used to control the climate within a facility (e.g., building). For example, the HVAC system can include a number of components that can be used to control the air temperature of different zones (e.g., rooms, areas, spaces, and/or floors) of a facility, in order to keep the zones in a comfort state for their occupants. The components of the HVAC system can include, for example, objects, control components, equipment, devices, networks, sensors, and/or actuators such as, for instance, valves such as heating and/or cooling valves, chillers (e.g., chiller plant), boilers (e.g., boiler plant), pumps such as hot water and/or chilled water pumps, fans, compressors, air dampers such as variable air volume (VAV) dampers, air handling units (AHUs) (e.g., AHU plant), coils such as heating and/or cooling coils, air filters, and/or cooling towers, among other components. The HVAC system may also include connections (e.g., physical connections) between the components, such as a chain of equipment (e.g., duct work, pipes, ventilation, and/or electrical and/or gas distribution equipment) that connects the components, among other connections.

Further, the HVAC system can include (e.g., be divided into) a number of zones. The zones of the HVAC system can correspond to the zones of the facility.

As shown in FIG. 1, system 100 can include a first model 102 and a second model 104. First model 102 can be, for example, a zone heat balance model that can be used to estimate unmeasured heat gains occurring in the zones of the HVAC system of the facility, and second model 104 can be, for example, a heating/cooling cost model that can be used to determine the costs associated with maintaining different temperature set points of the zones.

As shown in FIG. 1, a number of parameters 110-1, 110-2, . . . , 110-N associated with a zone of the HVAC system of the facility can be identified and input into first model 102 (e.g., as represented by arrows 101-1, 103-1, and 105-1, respectively). The parameters can include, for example, the coefficient of mixing for the supply air and the zone air, the coefficient of heat transfer through the external wall of the facility, and/or the coefficient of heat transfer to the facility mass.

In some embodiments, only parameters associated with the zone that affect (e.g., influence) the air temperature of the zone during a particular time interval may be input into first model 102. That is, in such embodiments, parameters associated with the zone that do not affect the air temperature of the zone, or have a negligible effect on the air temperature of the zone, during the particular time interval, may not be input into first model 102. The particular time interval can be, for example, one of a number of time intervals, such as a nighttime interval that corresponds to when the HVAC system is off and the facility is (or assumed to be) unoccupied, a morning interval that corresponds to when the HVAC system is started up, or a daytime interval that corresponds to when the HVAC system is operating and the facility is occupied.

The parameters associated with the zone that affect the air temperature of the zone during a particular time interval can be identified by, for example, grouping the number of parameters 110-1, 110-2, . . . , 110-N into a number of groups. Each respective group can correspond to a different time interval, and the parameters in each respective group are the parameters that affect the air temperature of the zone during the time interval to which that respective group corresponds. For instance, some of parameters 110-1, 110-2, . . . , 110-N may only affect the air temperature of the zone during a particular time interval or intervals, and accordingly those parameters would only be included in the group(s) corresponding to that time interval(s) (e.g., those parameters would not be included in the groups corresponding to other time intervals). The number of parameters in the group corresponding to the particular time interval (e.g., the parameters that affect the air temperature of the zone during the particular time interval) can be selected to be input into first model 102.

For example, during the nighttime interval when the HVAC system is off, parameters associated with the operation of the components of the HVAC system, such as the coefficient of mixing for the supply air and the zone air, may not be affecting the air temperature of the zone (e.g., because the supply air does not affect the air temperature of the zone while the HVAC system is off). As such, the group of parameters corresponding to the nighttime interval would not include these parameters, and these parameters would not be input into first model 102 for the nighttime interval. However, during the morning interval when the HVAC system is started up, the main prevailing effect on the air temperature of the zone may come from the HVAC system. Accordingly, the group of parameters corresponding to the morning interval may include the parameters associated with the operation of the components of the HVAC system, such as the coefficient of mixing for the supply air and the zone air, but may not include other parameters whose effect on the air temperature of the zone would be rendered negligible by the startup of the HVAC system. During the daytime interval when the HVAC system is operating and the facility is occupied, the parameters associated with the operation of the components of the HVAC system as well as the other parameters, such as coefficient of heat transfer through the external wall and coefficient of heat transfer to the facility mass, may affect the air temperature of the zone, and as such the group of parameters corresponding to the daytime interval would include all these parameters.

First model 102 can then be used to estimate an unmeasured (e.g., internal) heat gain 112 occurring in the zone based, at least in part, on the input parameters. For example, first model 102 can be used to estimate the unmeasured heat gain 112 occurring in the zone during a particular time interval based, at least in part, on the parameters in the group corresponding to that time interval (e.g., the parameters identified to affect the air temperature of the zone during that time interval) that was selected to be input into first model 102. The unmeasured heat gain 112 occurring in the zone can include, for example, solar heat gain occurring in the zone (e.g., heat from the sun coming in through the windows in the zone), heat from the occupants in the zone, and/or heat from the equipment in the zone, such as, for instance, heat from the computers in the zone, among other sources of unmeasured heat gain.

This process can be done (e.g., repeated) separately for each of the number of time intervals, such that first model 102 can be used to estimate the unmeasured heat gain 112 occurring in the zone during each respective time interval. For example, to estimate the unmeasured heat gain occurring in the zone over a particular 24 hour period, the group of parameters corresponding to the morning interval can be identified and input into first model 102, and first model 102 can estimate the unmeasured heat gain occurring in the zone during the morning interval based on those parameters. Then, the group of parameters corresponding to the daytime interval can be identified and input into first model 102, and first model 102 can estimate the unmeasured heat gain occurring in the zone during the daytime interval based on those parameters. Finally, the group of parameters corresponding to the nighttime interval can be identified and input into first model 102, and first model 102 can estimate the unmeasured heat gain occurring in the zone during the nighttime interval based on those parameters. Further, this process can be done separately for each respective zone of the HVAC system, such that first model 102 can be used to estimate the unmeasured heat gain occurring in each respective zone during each respective time interval. The identification of the parameters can be done, for example, using a least squares estimation, Kalman filtering, or particle filtering method.

The unmeasured heat gain 112 can be estimated, for example, by determining the difference between the actual (e.g., measured) air temperature of the zone and the air temperature of the zone predicted by first model 102 based on the input parameters. For example, first model 102 can give the change in zone air temperature T_{Z} by:

$$\frac{{dT}_{z}}{dt} = \frac{{α}_{mix}}{{C}_{air}} {c}_{air} \dot{m} ( {T}_{SA} - {T}_{z} ) + \frac{{α}_{extWall}}{{C}_{air}} ( {T}_{OA} - {T}_{z} ) + \frac{{Q}_{profile}}{{C}_{air}} + \frac{{Q}_{const}}{{C}_{air}} + \frac{{α}_{mass}}{{C}_{air}} ( {T}_{mass} - {T}_{z} )$$

and the change in facility mass temperature Tₘₐₛₛ by:

$$\frac{{dT}_{mass}}{dt} = \frac{{α}_{mass}}{{C}_{mass}} ( {T}_{z} - {T}_{mass} )$$

where αₘᵢₓ is the coefficient of mixing for the supply air and the zone air, Carr is the heat capacity of the zone air, cₐᵢᵣ is the specific heat capacity of air (e.g., 1,005 J/kg·K), \dot{m} is the supply air mass flow for the zone, T_{SA} is the supply air temperature for the zone, α_{extWall} is the coefficient of heat transfer through the external wall, T_{OA} is outside air temperature, Q_{profile} is the variable heat gain occurring in the zone (e.g., the heat from the occupants in the zone and the solar heat gain occurring in the zone), Q_{const} is the constant heat gain occurring in the zone (e.g., the heat from the equipment in the zone), αₘₐₛₛ is the coefficient of heat transfer to the facility mass, and Cₘₐₛₛ is the heat capacity of the facility mass. First model 102 can be solved for Q_{profile} and Q_{const}, which correspond to unmeasured heat gain 112, based on the parameters input into first model 102.

For example, during the nighttime interval, the change in zone air temperature T_{Z} and facility mass temperature Tₘₐₛₛ, respectively, given by first model 102 may reduce to:

$$\frac{{dT}_{z}}{dt} = \frac{{α}_{extWall}}{{C}_{air}} ( {T}_{OA} - {T}_{z} ) + \frac{{Q}_{const}}{{C}_{air}} + \frac{{α}_{mass}}{{C}_{air}} ( {T}_{mass} - {T}_{z} )$$

$$\frac{{dT}_{mass}}{dt} = \frac{{α}_{mass}}{{C}_{mass}} ( {T}_{z} - {T}_{mass} )$$

because the supply air temperature, supply air mass flow for the zone, and coefficient of mixing for the supply air and the zone air would not be input variables and parameters, respectively, for this time interval, and because the facility would be assumed to be unoccupied during this time interval, as previously described herein. Further, during the morning interval, the change in zone air temperature T_{Z} and facility mass temperature Tₘₐₛₛ, respectively, given by first model 102 may reduce to:

$$\frac{{dT}_{z}}{dt} = \frac{{α}_{mix}}{{C}_{air}} {c}_{air} \dot{m} ( {T}_{SA} - {T}_{z} ) + \frac{{α}_{extWall}}{{C}_{air}} ( {T}_{OA} - {T}_{z} ) + \frac{{Q}_{const}}{{C}_{air}} + \frac{{α}_{mass}}{{C}_{air}} ( {T}_{mass} - {T}_{z} )$$

$$\frac{{dT}_{mass}}{dt} = \frac{{α}_{mass}}{{C}_{mass}} ( {T}_{z} - {T}_{mass} )$$

because, as previously described herein, the supply air temperature, supply air mass flow for the zone, and coefficient of mixing for the supply air and the zone air would be input as variables and parameters, respectively, for this time interval.

As shown in FIG. 1, the estimated unmeasured heat gain 112 occurring in the zone can be input back into first model 102. Further, parameters 110-1, 110-2, . . . , 110-N can be re-input into first model 102 (e.g., as represented by arrows 101-2, 103-2, and 105-2, respectively), and an adjustment of the temperature set point of the zone (e.g., temperature set point adjustment 114) can be input into first model 102, as illustrated in FIG. 1. The adjustment can be, for example, an increase or decrease to the temperature set point proposed by an occupant of the facility, or by an operator (e.g., manager) of the HVAC system of the facility, in order to keep the zone in a comfort state.

First model 102 can then determine actions 115 associated with the proposed adjustment 114, such as actions the HVAC system of the facility would have to take to make the proposed adjustment 114, based on the estimated unmeasured heat gain 112 and the proposed adjustment 114. Actions the HVAC system of the facility may have to take to make the proposed adjustment may include, for example, adjusting (e.g., heating or cooling) the supply air temperature for the zone, and/or adjusting (e.g., increasing or decreasing) the supply air mass (e.g., volume) flow for the zone. As shown in FIG. 1, the actions 115 associated with the proposed adjustment can be input into second model 104.

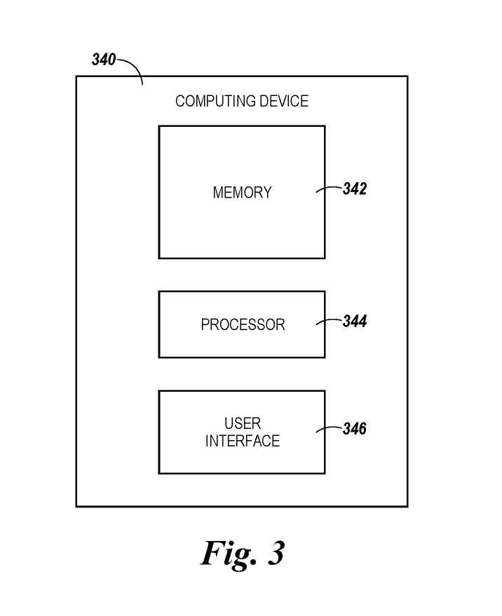

Second model 104 can then be used to determine the cost 124 associated with temperature set point adjustment 114 based, at least in part, on the estimated unmeasured heat gain 112 occurring in the zone. For example, second model 104 can be used to determine the cost 124 associated with temperature set point adjustment 114 based, at least in part, on the estimated unmeasured heat gain 112 occurring in the zone during each respective time interval. Further, this process can be done separately (e.g., repeated) for unmeasured heat gains estimated to be occurring in each respective zone of the HVAC system, such that second model 104 can be used to determine the costs associated with different temperature set point adjustments proposed for different zones that are input into second model 104. The cost 124 associated with temperature set point adjustment 114 can be provided to the occupant or operator, and/or can be sent to an additional device, as will be further described herein (e.g., in connection with FIG. 3).

As an example, second model 104 can determine the cost 124 associated with temperature set point adjustment 114 by determining, based at least in part on the estimated unmeasured heat gain 112 occurring in the zone, the cost associated with taking the actions 115 determined by first model 102 that would have to be taken by the HVAC systems of the facility to make the proposed adjustment. These actions can be balanced by an adjustable weighting parameter of second model 104, which can be preset (e.g., based on a control strategy for the HVAC system), or derived by second model 104 (e.g., from historical data associated with the HVAC system).

The cost associated with taking the actions 115 may depend on the amount of energy the HVAC system of the facility would consume in taking the actions. As such, second model 104 can determine the cost 124 associated with temperature set point adjustment 114 by determining the amount of energy the HVAC system of the facility would consume in taking the actions 115 to make the proposed adjustment, and determining the cost 124 associated with the proposed adjustment based on the determined amount of energy. For instance, second model 104 may determine the cost 124 associated with temperature set point adjustment 114 by multiplying the amount of energy the amount of energy the HVAC system of the facility would consume in taking the actions to make the proposed adjustment by the cost of the energy (e.g., the cost of electricity and/or fuel).

For example, for an adjustment to the supply air mass flow for the zone, the energy needed by the fan(s) of the HVAC system (e.g., the fan(s) associated with the zone) to make the adjustment can be determined from fan laws (e.g., the power may vary with the third power of mass flow, which is directly proportional to the rotation speed of the fan). For an adjustment to the supply air temperature for the zone, the outside/return air mix has to be heated or cooled by heating or cooling coils of the HVAC system (e.g., heating or cooling coils associated with the zone). The energy needed for this process can depend on a number of efficiency parameters associated with the HVAC system of the facility, the return air temperature for the zone, and the ratio of outside air to return air in the outside/return air mix for the zone.

As such, efficiency parameters 118 associated with the HVAC system of the facility, the return air temperature 120 for the zone, the outside/return air ratio 122 for the zone, and the air temperature outside the facility (e.g., the ambient air temperature) 123 can be input into second model 104, as illustrated in FIG. 1. Second model 104 can determine the energy needed for the adjustment to the supply air temperature, and therefore the cost 124 associated with temperature set point adjustment 114, based on efficiency parameters 118, return air temperature 120, outside/return air ratio 122, and outside air temperature 123.

Outside/return air ratio 122 can be determined, for example, based on the position of the mixing air damper of the HVAC system associated with the zone. Efficiency parameters 118 may include, for example, the efficiency of the heat exchange occurring in the HVAC system (e.g., the efficiency of the heating or cooling coils in heating or cooling the supply air), the efficiency of the heat transfer occurring in the duct(s) of the HVAC system associated with the zone, and/or the efficiency of the source of the heat being generated by the HVAC system (e.g., the efficiency of the boiler or chiller of the HVAC system). These parameters can be preset (e.g., as common values in practice), or estimated (e.g., based on operational data associated with the HVAC system).

FIG. 2 illustrates an example of a system 201 for determining costs associated with an HVAC system in accordance with one or more embodiments of the present disclosure. For example, system 201 can be used to determine the costs associated with maintaining, or not maintaining, components of the HVAC system used to keep the zones of the HVAC system in a comfort state, such as, for instance, the costs associated with (e.g., that would result from) a failure of the components, as will be further described herein. The HVAC system can be used to control the climate within a facility (e.g., building), and can include a number of zones that correspond to the zones of the facility, in a manner analogous to that previously described in connection with FIG. 1.

As shown in FIG. 2, system 201 can include a first model 202, a second model 206, and a control strategy model 207. First model 202 can be, for example, a zone heat balance model analogous to first model 102 previously described in connection with FIG. 1, however used in a different way, as will be further described herein. First model 202, in combination with control strategy model 207, can be used to estimate a zone air temperature profile 234 in response to profiles of exogenous variables acting on first model 202 and control strategy model 207. Second model 206 can be, for example, a cost model that can be used to determine the cost associated with a failure of the components of the HVAC system.

As shown in FIG. 2, a number of parameters 210-1, 210-2, . . . , 210-N associated with a zone of the HVAC system of the facility can be identified and input into first model 202. Parameters 210-1, 210-2, . . . , 210-N can be analogous to parameters 110-1, 110-2, . . . , 110-N previously described in connection with FIG. 1. For example, in some embodiments, only parameters associated with the zone that affect (e.g., influence) the air temperature of the zone during a particular time interval may be input into first model 202, in a manner analogous to that previously described in connection with FIG. 1.

First model 202 can then be used to determine a daily temperature profile 234 for the zone based, at least in part, on the profiles of exogenous variables. The daily temperature profile 234 for the zone can be, for instance, the profile of the air temperature of the zone over a particular 24 hour period (e.g., a 24 hour period that includes a nighttime interval that corresponds to when the HVAC system is off and the facility is (or assumed to be) unoccupied, a morning interval that corresponds to when the HVAC system is started up, and a daytime interval that corresponds to when the HVAC system is operating and the facility is occupied).

First model 202 may determine the daily temperature profile 234 for the zone based, at least in part, on a daily outside (e.g., ambient) air temperature profile 230 for the facility. The daily outside air temperature profile for the facility can be, for instance, the typical profile of the air temperature outside the facility over a particular 24 hour period.

For example, daily outside air temperature profile 230 for the facility can be determined based on historical weather data for the location of the facility. For instance, the air temperature measurements for a particular day of the year over a number of different years can be used to determine (e.g., compute) the mean and/or standard deviation for the outside air temperature profile for that day. The determined daily outside air temperature profile 230 can then be input into first model 202, as illustrated in FIG. 2, and used in combination with the internal heat gain profile 238 for the zone and the amount of heat 232 provided to the zone to determine the daily zone temperature profile 234 for the zone.

First model 202 may also determine the daily temperature profile 234 for the zone based, at least in part, on the internal heat gain profile 238 for the zone. The internal heat gain profile for the zone can be, for instance, the typical profile of the internal heat gain for the zone over a particular 24 hour period, and can include the solar heat gain occurring in the zone, and the heat produced by occupants and/or equipment in the zone.

For example, internal heat gain profile 238 for the zone can be determined based on the profile used in the “design phase” when selecting and sizing the HVAC system for the facility (e.g., the internal heat gain profile can be estimated based on the expected use of the zone). As an additional example, internal heat gain profile 238 for the zone can be determined based on the occupancy schedule for the zone, the utilization of the zone, and/or the size of the zone.

As an additional example, internal heat gain profile 238 for the zone can be determined based on historical heat gain estimates, such as unmeasured heat gain 112 estimated using first model 102 as previously described in connection with FIG. 1. For instance, historical heat gain estimates can be used to determine (e.g., compute) the mean and/or standard deviation for the internal heat gain profile 238.

The determined internal heat gain profile 238 can then be input into first model 202, as illustrated in FIG. 2, and used in combination with daily outside air temperature profile 230 and the heat provided to the zone 232 to determine the daily zone temperature profile 234 for the zone.

First model 202 may also determine the daily temperature profile 234 for the zone based, at least in part, on the amount of heat 232 provided to the zone by the HVAC system. The amount of heat 232 provided to the zone by the HVAC system can be determined, for example, based on control strategy model 207.

For example, as shown in FIG. 2, a number of parameters 220-1, 220-2, . . . , 220-M associated with the zone of the HVAC system of the facility can be identified and input into control strategy model 207.

Parameters 220-1, 220-2, . . . , 220-M can include, for example, parameters of reset curves of the temperature control strategy of the HVAC system for the zone, and/or parameters of static approximation of the temperature control strategy of the HVAC system for the zone. Further, some of parameters 220-1, 220-2, . . . , 220-M may be subject to change during the failure of equipment of the HVAC system.

For example, the amount of heat 232 provided to the zone by the HVAC system can be determined by control strategy model 207 based, at least in part, on the temperature set point profile 239 for the zone. Temperature set point profile 239 for the zone can be, for instance, the assumed profile of the temperature set point for the zone over a particular 24 hour period.

For example, the amount of heat 232 provided to the zone by the HVAC system can be determined by control strategy model 207 based on the temperature control strategy of the HVAC system for the zone.

For instance, the temperature control strategy can be used to directly determine (e.g., calculate) the actions the HVAC system is taking to control the temperature of the zone, and thus the heat being provided to the zone by the HVAC system.

As an additional example, the amount of heat 232 provided to the zone by the HVAC system can be determined by control strategy model 207 based on the amount of energy used by the HVAC system to heat the zone (e.g., the zone load) during the different weather conditions. For instance, if the temperature control strategy for the zone is not available, the zone load can be mapped to the different weather conditions to construct the dependency between the zone load and the weather conditions, which can provide a static approximation of the temperature control strategy for the zone.

The amount of heat 232 determined to be provided to the zone by the HVAC system can then be input into first model 202, as illustrated in FIG. 2, and used in combination with the internal heat gain profile 238 for the zone and/or the daily outside air temperature profile 230 for the facility to determine the daily zone temperature profile 234 for the zone. This process can be done separately for each respective zone of the HVAC system, such that first model 202 can be used to determine the daily zone temperature profile for each respective zone.

As shown in FIG. 2, the daily zone temperature profile 234 for the zone can be input into second model 206. Second model 206 can then be used to determine the cost 236 associated with (that would result from) the failure of a component of the HVAC system that is associated with the zone based, at least in part, on the daily zone temperature profile 234. This process can be done separately (e.g., repeated) for the daily zone temperature profile for each respective zone of the HVAC system, such that second model 206 can be used to determine the costs associated with the failure of different components of the HVAC system associated with the different zones. The cost 236 associated with the component failure can be provided to the occupant or operator, and/or can be sent to an additional device, as will be further described herein (e.g., in connection with FIG. 3), and can provide a monetization of the discomfort that may result from the component failure, such as, for example, a prediction of such a monetization over long time horizons (e.g., multiple years).

FIG. 3 illustrates a computing device 340 for determining costs associated with an HVAC system in accordance with one or more embodiments of the present disclosure. Computing device 340 can be, for example, a laptop computer, desktop computer, or mobile device (e.g., smart phone, tablet, PDA, etc.), among other types of computing devices. However, embodiments of the present disclosure are not limited to a particular type of computing device. In some embodiments, computing device 340 can be an HVAC system controller used (e.g., by an operator) to control an HVAC system of a facility.

As shown in FIG. 3, computing device 340 can include a memory 342 and a processor 344. Memory 342 can be any type of storage medium that can be accessed by processor 344 to perform various examples of the present disclosure. For example, memory 342 can be a non-transitory computer readable medium having computer readable instructions (e.g., computer program instructions) stored thereon that are executable by processor 344 to determine costs associated with an HVAC system, such as the costs associated with keeping the zones of the HVAC system in a comfort state and/or the costs associated with maintaining (or not maintaining) the components of the HVAC system used to keep the zones in a comfort state, in accordance with the present disclosure. That is, processor 344 can execute the executable instructions stored in memory 342 to determine costs associated with an HVAC system in accordance with the present disclosure.

Memory 342 can be volatile or nonvolatile memory. Memory 342 can also be removable (e.g., portable) memory, or non-removable (e.g., internal) memory. For example, memory 342 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 342 is illustrated as being located in computing device 340, embodiments of the present disclosure are not so limited. For example, memory 342 can also be located internal to another computing resource (e.g., enabling computer readable instructions to be downloaded over the Internet or another wired or wireless connection).

As shown in FIG. 3, computing device 340 can include a user interface 346. A user (e.g., operator) of computing device 100, such as, for instance, an operator (e.g., manager) of the HVAC system of the facility, can interact with computing device 340 via user interface 346. For example, user interface 346 can provide (e.g., display and/or present) information to the user of computing device 340, such as, for instance, costs associated with the HVAC system (e.g., the costs associated with keeping the zones of the HVAC system in a comfort state and/or the costs associated with maintaining (or not maintaining) the components of the HVAC system used to keep the zones in a comfort state) determined by computing device 340. Further, user interface 346 can receive information from (e.g., input by) the user of computing device 340.

In some embodiments, user interface 346 can be a graphical user interface (GUI) that can include a display (e.g., a screen) that can provide and/or receive information to and/or from the user of computing device 340. The display can be, for instance, a touch-screen (e.g., the GUI can include touch-screen capabilities). As an additional example, user interface 346 can include a keyboard and/or mouse the user can use to input information into computing device 340. Embodiments of the present disclosure, however, are not limited to a particular type(s) of user interface.

In some embodiments, computing device 340 can send (e.g., transmit) the costs associated with the HVAC system determined by computing device 340 to an additional device. For example, computing device 340 can send the determined costs to thermostats in the zones of the HVAC system, and/or to the mobile devices of the operator of the HVAC system and/or the occupants of the facility. Computing device 340 can send the determined costs to the additional device(s) via a wired or wireless network, as will be appreciated by one of skill in the art.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for determining a cost associated with a heating, ventilation, and air conditioning (HVAC) system, comprising:
a memory; and
a processor configured to execute executable instructions stored in the memory to:
identify a number of parameters associated with a zone of an HVAC system of a facility to input into a first model configured to estimate unmeasured heat gains occurring in the zone of the HVAC system of the facility;
input the identified parameters into the first model;
estimate, using the first model, an unmeasured heat gain occurring in the zone based, at least in part, on the input parameters;
input actions associated with an adjustment of a temperature set point of the zone, based on the estimated unmeasured heat gain occurring in the zone and the adjustment of the temperature set point of the zone, into a second model configured to determine costs associated with maintaining different temperature set points of the zone; and
determine, using the second model, a cost associated with the adjustment of a temperature set point of the zone based, at least in part, on the estimated unmeasured heat gain occurring in the zone.

2. The computing device of claim 1, wherein the identified parameters include only parameters associated with the zone that affect an air temperature of the zone during a particular time interval.

3. The computing device of claim 1, wherein the processor is configured to execute the instructions to estimate, using the first model, the unmeasured heat gain occurring in the zone during a number of time intervals based, at least in part, on the input parameters.

4. The computing device of claim 3, wherein the number of time intervals include:
a nighttime interval;
a morning interval; and
a daytime interval.

5. The computing device of claim 1, wherein the processor is configured to execute the instructions to:
identify the number of parameters to input into the first model by:
grouping the number of parameters into a number of groups, wherein:
each respective group corresponds to a different time interval; and
the number of parameters in each respective group are parameters that affect an air temperature of the zone during the time interval to which that respective group corresponds; and
selecting the number of parameters in a particular one of the number of groups to input into the first model;
input the selected number of parameters into the first model; and
estimate, using the first model, the unmeasured heat gain occurring in the zone during the time interval that corresponds to that particular group based, at least in part, on the input parameters.

6. The computing device of claim 1, wherein the processor is configured to execute the instructions to estimate the unmeasured heat gain occurring in the zone by determining a difference between an actual air temperature of the zone and an air temperature of the zone predicted by the first model based on the input parameters.

7. The computing device of claim 1, wherein the processor is configured to execute the instructions to:
input the estimated unmeasured heat gain occurring in the zone, and the adjustment of the temperature set point of the zone, into the first model;
determine, using the first model, actions the HVAC system of the facility would have to take to make the adjustment; and
determine, using the second model, the cost associated with the adjustment of the temperature set point of the zone by determining, based at least in part on the estimated unmeasured heat gain occurring in the zone, a cost associated with taking the determined actions the HVAC system of the facility would have to take to make the adjustment.

8. The computing device of claim 7, wherein the actions the HVAC system of the facility would have to take to make the adjustment include:
an adjustment of a supply air temperature for the zone; and
an adjustment of a supply air mass flow for the zone.

9. The computing device of claim 1, wherein the processor is configured to execute the instructions to determine, using the second model, the cost associated with the adjustment of the temperature set point of the zone by:
determining an amount of energy the HVAC system of the facility would consume in making the adjustment based, at least in part, on the estimated unmeasured heat gain occurring in the zone; and
determining the cost associated with the adjustment based on the determined amount of energy the HVAC system of the facility would consume in making the adjustment.

10. The computing device of claim 1, wherein the processor is configured to execute the instructions to determine, using the second model, the cost associated with the adjustment of the temperature set point of the zone based, at least in part, on:
a number of efficiency parameters of the HVAC system;
a return air temperature for the zone;
a ratio of outside air in the return air for the zone; and
an air temperature outside the facility.

11. The computing device of claim 1, wherein the number of parameters associated with the zone include:
a coefficient of mixing for supply air and zone air of the zone;
a coefficient of heat transfer through an external wall of the facility; and
a coefficient of heat transfer to the facility mass.

12. A method for determining a cost associated with a heating, ventilation, and air conditioning (HVAC) system, comprising:
inputting a number of parameters associated with a zone of an HVAC system of a facility into a first model configured to determine a daily temperature profile for the zone of the HVAC system of the facility;
determining, using the first model, the daily temperature profile for the zone based, at least in part, on an internal heat gain profile for the zone;
inputting the daily temperature profile for the zone into a second model configured to determine costs associated with failures of components of the HVAC system; and
determine, using the second model, a cost associated with a failure of a component of the HVAC system that is associated with the zone based, at least in part, on the daily temperature profile.

13. The method of claim 12, wherein the internal heat gain profile for the zone includes:
a solar heat gain occurring in the zone;
heat from occupants in the zone; and
heat from equipment in the zone.

14. The method of claim 12, wherein the method includes:
determining, based on historical weather data, a daily outside air temperature profile for the facility;
inputting the daily outside air temperature profile for the facility into the first model; and
determining, using the first model, the daily temperature profile for the zone based, at least in part, on the daily outside air temperature profile for the facility.

15. The method of claim 12, wherein the method includes:
determining, based on a control strategy model, an amount of heat provided to the zone by the HVAC system;
inputting the amount of heat provided to the zone by the HVAC system into the first model; and
determining, using the first model, the daily temperature profile for the zone based, at least in part, on the amount of heat provided to the zone by the HVAC system.

16. The method of claim 12, wherein the method includes:
determining, based on an amount of energy used by the HVAC system to heat the zone, an amount of heat provided to the zone by the HVAC system;
inputting the amount of heat provided to the zone by the HVAC system into the first model; and
determining, using the first model, the daily temperature profile for the zone based, at least in part, on the amount of heat provided to the zone by the HVAC system.

17. A non-transitory computer readable medium having computer readable instructions stored thereon that are executable by a processor to:
determine, using a model configured to estimate unmeasured heat gains occurring in a zone of a heating, ventilation, and air conditioning (HVAC) system of a facility a cost associated with an adjustment of a temperature set point of the zone; and
determine, using a model configured to determine a daily temperature profile for the zone of the HVAC system of the facility, a cost associated with a failure of a component of the HVAC system that is associated with the zone.

18. The computer readable medium of claim 17, wherein the instructions are executable by the processor to determine the cost associated with the adjustment of the temperature set point of the zone by:
identifying a number of parameters associated with the zone to input into the model configured to estimate unmeasured heat gains;
inputting the identified parameters into the model configured to estimate unmeasured heat gains;
estimating, using the model configured to estimate unmeasured heat gains, an unmeasured heat gain occurring in the zone based, at least in part, on the input parameters;
inputting actions associated with an adjustment of a temperature set point of the zone, based on the estimated unmeasured heat gain occurring in the zone and the adjustment of the temperature set point of the zone, into an additional model configured to determine costs associated with maintaining different temperature set points of the zone; and
determining, using the additional model, the cost associated with the adjustment of a temperature set point of the zone based, at least in part, on the unmeasured heat gain estimated using the model.

19. The computer readable medium of claim 17, wherein the instructions are executable by the processor to determine the cost associated with the failure of the component of the HVAC system that is associated with the zone by:
inputting a number of parameters associated with the zone into the model configured to determine the daily temperature profile for the zone;
determining, using the model configured to determine the daily temperature profile for the zone, the daily temperature profile for the zone based, at least in part, on an internal heat gain profile for the zone, a daily outside air temperature profile for the facility, and an amount of heat provided to the zone by the HVAC system;
inputting the daily temperature profile for the zone into an additional model configured to determine costs associated with failures of components of the HVAC system; and
determining, using the additional model, the cost associated with the failure of the component based, at least in part, on the daily temperature profile.

20. The computer readable medium of claim 17, wherein the instructions are executable by the processor to send the determined cost associated with the adjustment of the temperature set point of the zone and the determined cost associated with the failure of the component of the HVAC system that is associated with the zone to a mobile device.
